(19) United States
(12) Patent Application Publication
(10) Pub. No.: US 2024/0318920 A1
(43) Pub. Date: Sep. 26, 2024

(54) HEAT EXCHANGER AND MANUFACTURING METHOD THEREFOR

(71) Applicant: ZHEJIANG ASCENRISE HEAT PUMP CO., LTD., Jinhua (CN)

(72) Inventor: Kaijian WANG, Jinhua (CN)

(21) Appl. No.: 18/575,731

(22) PCT Filed: Jun. 30, 2022
(86) PCT No.: PCT/CN2022/102969

§ 371 Date: Dec. 29, 2023

(30) Foreign Application Priority Data
Jun. 30, 2021 (CN) 202110738485.4
Sep. 30, 2021 (CN) 202111161532.X

(51) Int. Cl. F28D 9/00; B23P 15/26

(52) U.S. Cl. CPC F28D 9/0075; B23P 15/26

(57) ABSTRACT

A heat exchanger and a manufacturing method therefor. The heat exchanger comprises a plurality of working fluid channel sheets (1) stacked in the 0-Z direction. The working fluid channel sheets (1) each comprise an inlet (2), an outlet (3), and a heat exchange region (4) located between the inlet (2) and the outlet (3): the heat exchange regions (4) are provided with a plurality of microstructures (5) formed by stamping; center points of the microstructures (5) on adjacent working fluid channel sheets (1) are aligned in the 0-XY direction, and the shape of the microstructures (5) on adjacent working fluid channel sheets (1) are different. In the present invention, a part of a region of each microstructure (5) does not correspond to a recess in the adjacent working fluid channel sheet (1) and overlaps a region on a periphery of the recess, thereby realizing atomic diffusion bonding.

### TECHNICAL FIELD

The present invention relates to the technical field of heat exchange, and particularly relates to a heat exchanger and a manufacturing method therefor.

### BACKGROUND

A heat exchanger is a system for transferring heat between two or more fluids. Based on the characteristics of transfer of heat from high temperature to low temperature, heat is transferred from a hot fluid to a cold fluid to heat or cool objects.

A microchannel heat exchanger is a novel heat exchanger formed by alternately stacking working fluid channel sheets with refrigerant channels and working fluid channel sheets with working fluid channels. However, the refrigerant channels and the working fluid channels are all formed by physical etching or chemical etching, and thus, have the defects of high material consumption, high manufacturing cost, low production efficiency and certain pollution to the environment.

In view of this, it is necessary to provide a novel heat exchanger and a manufacturing method therefor.

### SUMMARY

The present invention aims to provide a heat exchanger and a manufacturing method therefor.

In order to solve one of the above technical problems, the present invention adopts the following technical solutions:

A heat exchanger includes a plurality of working fluid channel sheets stacked along an O-Z direction, the working fluid channel sheet include an inlet, an outlet and a heat exchange region located between the inlet and the outlet, the heat exchange region is provided with a plurality of microstructures formed by stamping, center points of the microstructures on the adjacent working fluid channel sheets are aligned along an O-XY direction, and the microstructures on the adjacent working fluid channel sheets have different shapes.

Further, the working fluid channel sheets include a plurality of first working fluid channel sheets and a plurality of second working fluid channel sheets alternately stacked, and the microstructures include first microstructures disposed on the first working fluid channel sheets and second microstructures disposed on the second working fluid channel sheets, in the O-XY direction, a part of a first edge portion of the first microstructure exceeds the second microstructure, and/or a part of a second edge portion of the second microstructure exceeds the first microstructure.

Further, the first working fluid channel sheets each include a first inlet, a first outlet and a first heat exchange region located between the first inlet and the first outlet, the first heat exchange region is provided with a plurality of first microstructures; and the second working fluid channel sheets each include a second inlet, a second outlet and a second heat exchange region located between the second inlet and the second outlet, the second heat exchange region is provided with a plurality of second microstructures.

A method for manufacturing a heat exchanger includes the following steps:
forming first working fluid channel sheets, the first working fluid channel sheets each including a first inlet, a first outlet and a first heat exchange region located between the first inlet and the second inlet, and the first heat exchange region having a plurality of first microstructures formed by stamping;
forming second working fluid channel sheets, the second working fluid channel sheets each including a second inlet, a second outlet and a second heat exchange region located between the second inlet and the second outlet, the second heat exchange region having a plurality of second microstructures formed by stamping, and the first microstructures and the second microstructures having different shapes;
stacking the first working fluid channel sheets and the second working fluid channel sheets alternately along the O-Z direction, center points of the first microstructures and the second microstructures being aligned along the O-XY direction, the plurality of first inlets being aligned along the O-XY direction, the plurality of second inlets being aligned along the O-XY direction, and the plurality of first inlets, the plurality of first outlets, the plurality of second inlets and the plurality of second outlets being disposed in a staggered manner; and
bonding the first working fluid channel sheets and the second working fluid channel sheets stacked together by atomic diffusion.

The present invention has the following beneficial effects: The microstructures on the adjacent working fluid channel sheets have different shapes, the center points of the microstructures on the adjacent working fluid channel sheets are aligned along the O-XY direction, and a part of a region of each microstructure does not correspond to a recess in the adjacent working fluid channel sheet and overlaps a region on a periphery of the recess, thereby realizing atomic diffusion bonding.

### BRIEF DESCRIPTION OF THE DRAWINGS

FIG. 1 is a schematic structural view of a heat exchanger in an embodiment of the present invention;

FIG. 2 is a partially exploded view of FIG. 1 from another angle;

FIG. 3 is a schematic perspective view of a plurality of microstructure sheets and gaskets stacked in the heat exchanger shown in FIG. 1;

FIG. 4 is a partial enlarged view of FIG. 3;

FIG. 5 is a schematic view of a first microstructure sheet and a first microstructure sheet gasket in FIG. 1 after stacked;

FIG. 6 is a schematic structural view of the first microstructure sheet in FIG. 5;

FIG. 7 is a schematic structural view of the first microstructure sheet gasket in FIG. 5;

FIG. 8 is a schematic view of a second microstructure sheet and a second microstructure sheet gasket in FIG. 1 after stacked;

FIG. 9 is a schematic structural view of the second microstructure sheet in FIG. 8;

FIG. 10 is a schematic structural view of the second microstructure sheet gasket in FIG. 8;

FIG. 11 is a schematic structural view of a first sheet in a preferred embodiment;

FIG. 12 is a schematic perspective view of a plurality of microstructure sheets and gaskets stacked in another embodiment of the present invention;

FIG. 13 is a partial enlarged view of FIG. 12;

FIG. 14 is a schematic structural view of the first microstructure sheet in FIG. 12;

FIG. 15 is a schematic structural view of the first microstructure sheet gasket in FIG. 12;

FIG. 16 is a schematic structural view of the second microstructure sheet in FIG. 12; and

FIG. 17 is a schematic structural view of the second microstructure sheet gasket in FIG. 12.

### DETAILED DESCRIPTION

The present invention will be described in detail below in conjunction with specific implementations shown in the accompanying drawings. However, these implementations do not limit the present invention, and structural, methodological or functional changes made by those of ordinary skill in the art according to these implementations shall all fall within the protection scope of the present invention.

In the drawings of the present invention, for the convenience of description, some dimensions of structures or parts are exaggerated relative to other structures or parts, and therefore, are merely used to illustrate the basic structure of the subject matter of the present invention.

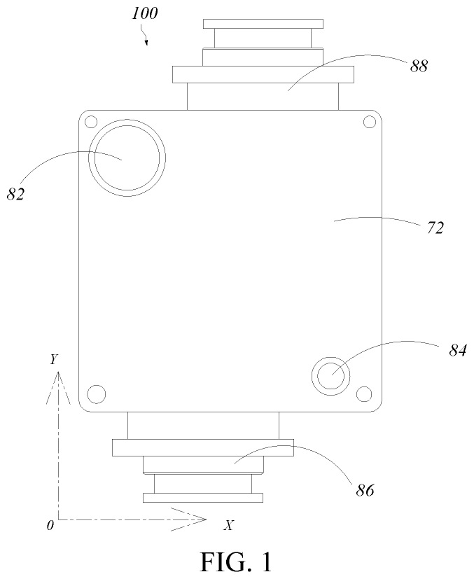

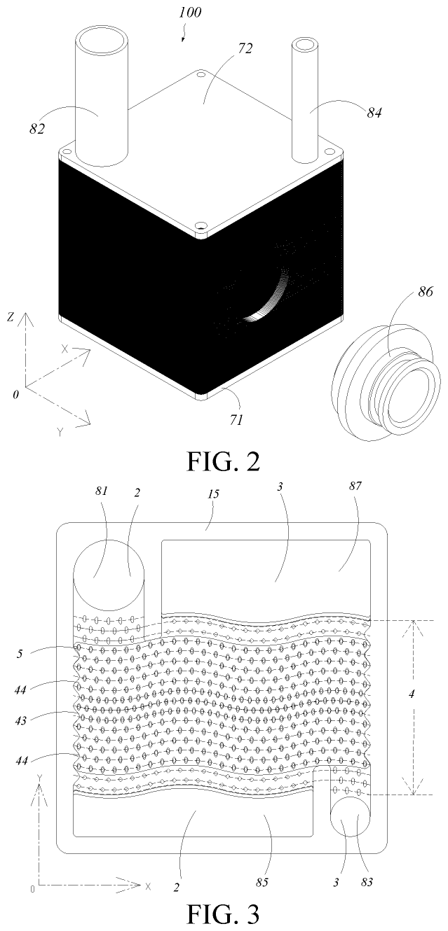

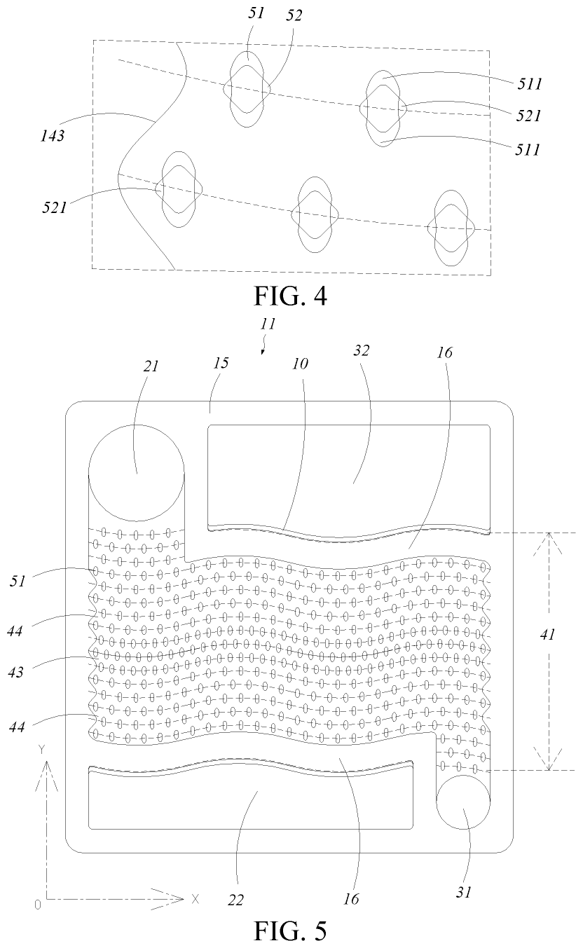

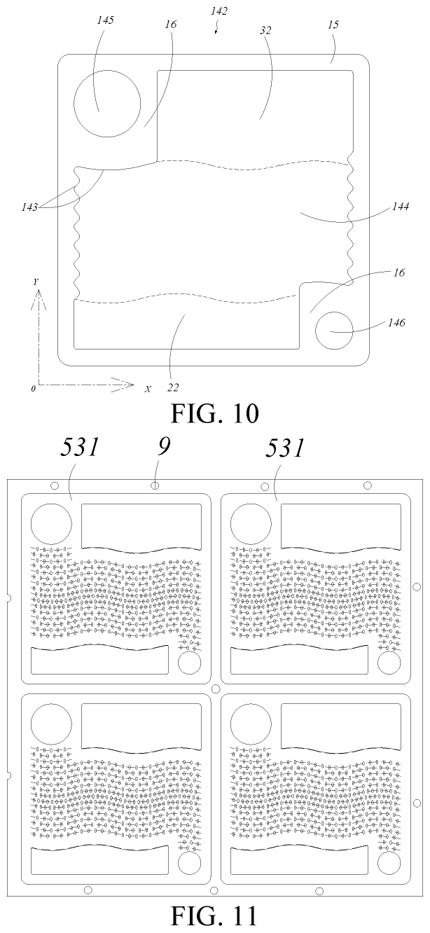

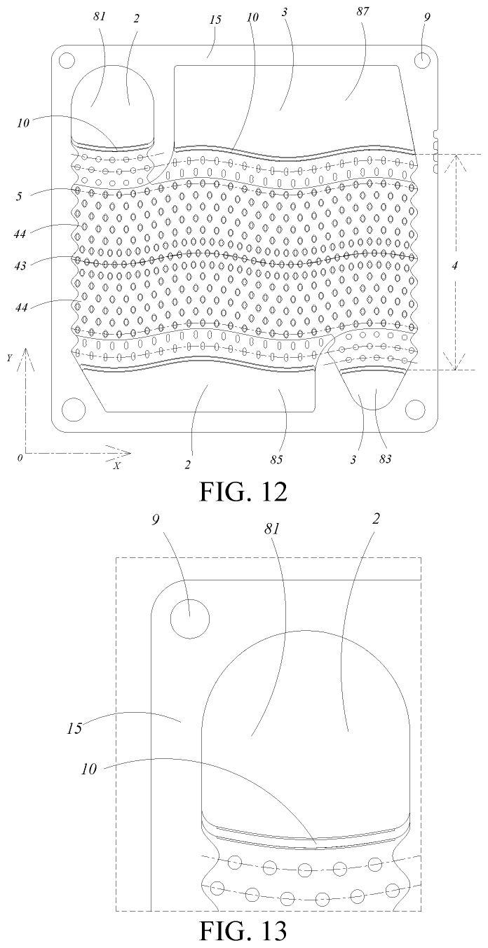

Based on a “thermal resistance equilibrium theory”, a stamping process and an atomic diffusion bonding process, the present invention aims to design a heat exchanger 100 with low manufacturing cost, compact structure and good heat exchange performance and suitable for mass production, and a manufacturing method therefor. However, some of the designs may also be used for heat exchangers 100 manufactured by other processes. FIG. 1 to FIG. 11 show a first embodiment of the present invention, and FIG. 12 to FIG. 17 show a second embodiment of the present invention. For the convenience of description, a coordinate system O-XYZ is set.

The heat exchanger 100 includes a plurality of working fluid channel sheets 1. The working fluid channel sheets 1 extend substantially along an O-XY direction. The plurality of working fluid channel sheets 1 are stacked along an O-Z direction. A working fluid channel for a working fluid to circulate is formed between every two adjacent working fluid channel sheets 1. An edge of the working fluid channel sheet 1 has an inlet 2 and an outlet 3 communicating with the working fluid channel, and the inlet 2 and the outlet 3 of the two adjacent working fluid channel sheets 1 are disposed in a staggered manner along the O-XY direction.

The two adjacent working fluid channels are respectively configured to circulate a first working fluid and a second working fluid, heat is transferred when there is a temperature difference between the first working fluid and the second working fluid. The first working fluid and the second working fluid refer to two working fluids exchanging heat according to settings. The two working fluids may be made of the same material but have different temperatures, or may be made of different materials and have different temperatures.

Common features of the two embodiments will be described below first.

Referring to FIG. 1 to FIG. 17, the working fluid channel sheet 1 includes the inlet 2, the outlet 3 and a heat exchange region 4 located between the inlet 2 and the outlet 3. The heat exchange region 4 is provided with a plurality of microstructures 5 to divide the working fluid channel into a plurality of parallel or cross-communicated microchannels, so as to improve the heat exchange performance of the heat exchanger 100.

The size and pitch of the microstructures 5 affect the heat exchange performance and pressure loss. In a preferred embodiment, the microstructures 5 have an equivalent diameter of not greater than 0.7 mm, preferably not smaller than 0.5 mm. The pitch between every two adjacent microstructures 5 is 0.5-2.5 mm, preferably 1-1.5 mm.

Specifically, the working fluid channel sheet 1 further includes an enclosure dam 6 disposed around the heat exchange region 4, and the enclosure dam 6 is located at a side where the microstructures 5 are disposed to prevent the working fluid from flowing outward. The inlet 2 and the outlet 3 are disposed on the enclosure dam 6 or located at an inner side of the enclosure dam facing the heat exchange region 4.

The plurality of microstructures 5 are arranged at intervals along a plurality of sine curves, and the plurality of sine curves are arranged at intervals from the side where the inlet 2 is located to the side where the outlet 3 is located. The microstructures 5 are arranged according to the sine curves, so that the simple microstructures 5 can function as sine curve-shaped guide structures, which reduces the difficulty in production of the microstructures 5 and makes the working fluid have a flow trend along the sine curves, thereby producing good turbulence effects and ensuring heat exchange performance.

In a preferred embodiment, the inlet 2 and the outlet 3 are respectively disposed on two sides of the heat exchange region 4 along an O-Y direction, the sine curve extends along an O-X direction, and the plurality of sine curves are arranged at intervals along the O-Y direction. After the working fluid enters the working fluid channel from the inlet 2, under the disturbance of the plurality of microstructures 5, it gradually moves downstream to the outlet 3 wave by wave. The plurality of microstructures 5 guides the fluid to flow like waves, producing great disturbance to the fluid and good heat exchange performance.

Preferably, the plurality of microstructures 5 arranged along the sine curve have the same pitch therebetween along the O-X direction, that is, when the plurality of microstructures 5 distributed along the sine curve are projected onto the same straight line along the O-Y direction, these projections are uniformly distributed along the O-X direction. Therefore, when the adjacent working fluid channel sheets 1 are stacked, the two adjacent working fluid channel sheets 1 have uniform supporting/bonding points.

Further, the microstructures 5 distributed along every two adjacent sine curves are arranged in a staggered manner along the O-X direction, that is, projections of each of the microstructures 5 on adjacent sine curves along the O-Y direction are located in the middle of the two adjacent microstructures 5 on the sine curves onto which the microstructure is projected. This further improves the uniformity of the supporting/bonding points in the whole region, and enhances the disturbance to the working fluid, thereby improving the heat exchange performance.

In addition, along a direction from a side where the inlet 2 is located to a side where the outlet 3 is located, the heat exchange region 4 includes a turbulent region 43 and transition regions 44 located on two sides of the turbulent region 43. A density of the microstructures 5 disposed in the turbulent region 43 is greater than a density of the microstructures 5 disposed in the transition region 44. Specifically, a number of the microstructures 5 distributed on any sine curve in the transition region 44 is smaller than a number of the microstructures 5 on any sine curve in the turbulent region 43; and/or a pitch between every two adjacent sine curves in the transition region 44 is greater than a pitch between every two adjacent sine curves in the turbulent region 43.

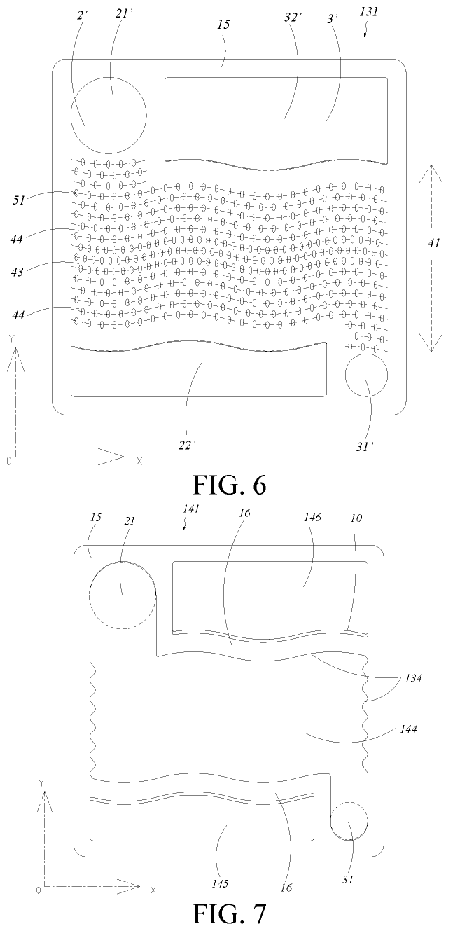

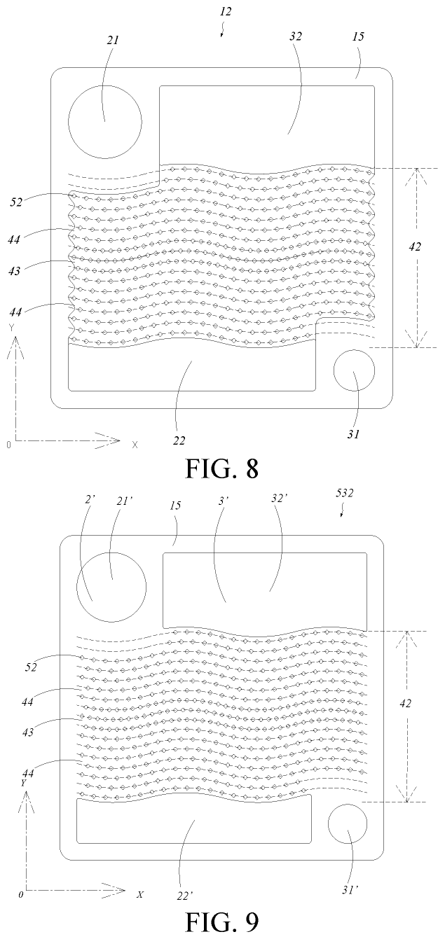

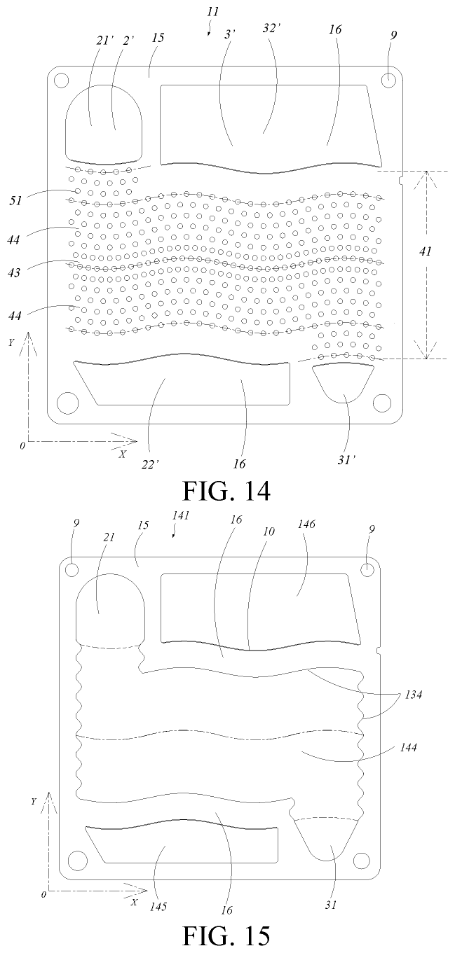

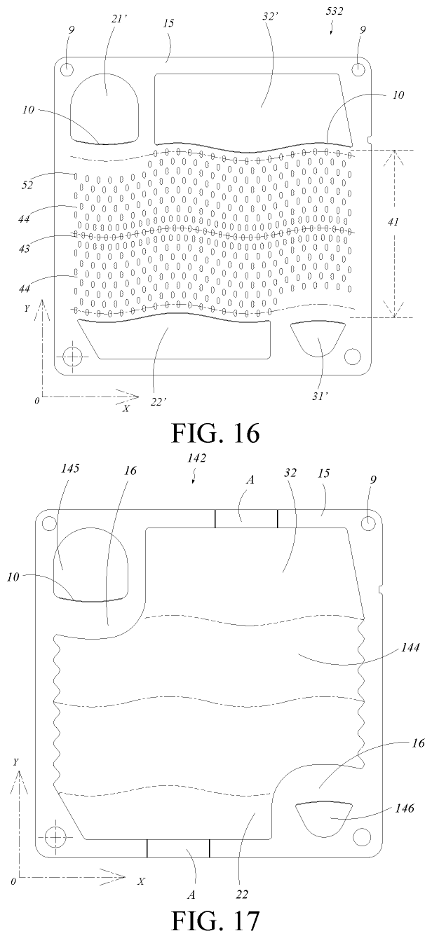

As shown in FIG. 3, FIG. 5 to FIG. 6, FIG. 8 to FIG. 9, FIG. 11 to FIG. 12. FIG. 14 and FIG. 16, the number of the microstructures 5 distributed on any sine curve in the transition region 44 is smaller than the number of the microstructures 5 on any sine curve in the turbulent region 43. Every two adjacent sine curves in the turbulent region 43 and the transition region 44 have the same pitch therebetween, which is preferably the minimum value that can be achieved by the existing process, so as to ensure the heat exchange performance and also reduce the size of the heat exchanger 100 along the O-Y direction.

Disposing the turbulent region 43 can improve the heat exchange performance of the heat exchange region 4 with the same area by 30%. The greater the width of the turbulent region 43 along the O-Y direction, the better the heat exchange performance. The width of the turbulent region 43 is set as follows: 1) the width of the turbulent region 43 is smaller than or equal to 3 mm, preferably 2-3 mm; or 2) the width of the turbulent region 43 can accommodate a number of smaller than or equal to 3 sine curves, preferably 2-3 sine curves.

Both of the two settings of the width take the heat exchange performance of the turbulent region 43, the size of the heat exchanger 100, the preparation process and the pressure loss into consideration, so that the heat exchanger 100 has the smallest length along the O-Y direction on the premise of ensuring the heat exchange performance, thereby saving the material and occupying less space. If the width of the turbulent region 43 is further increased, the heat exchange performance will not be significantly improved, but the pressure loss and flow loss will be greatly increased.

In addition, when the microstructures 5 are formed by stamping, corresponding recesses are formed on the other side. If the microstructures 5 on the two adjacent working fluid channel sheets 1 and the arrangements thereof are the same, when the sheets are stacked, the microstructure 5 on one working fluid channel sheet 1 directly faces the corresponding recess in the other working fluid channel sheet 1. In this case, atomic diffusion bonding cannot be realized. In order to solve this technical problem, as shown in FIG. 3 to FIG. 4 and FIG. 12 to FIG. 13, center points of the microstructures 5 on the two adjacent working fluid channel sheets 1 are aligned along the O-XY direction, that is, the connecting line between the two center points is parallel to the O-Z direction, and the supporting/bonding points on the two adjacent working fluid channel sheets 1 are aligned, thereby preventing bonding points from breaking due to different pressures of two working fluids. Moreover, the microstructures 5 on the two adjacent working fluid channel sheets 1 have different shapes, so that a part of a region of each microstructure 5 does not correspond to the recess in the adjacent microstructure sheet 13 and overlaps a region on a periphery of the recess, thereby realizing atomic diffusion bonding.

When the microstructure 5 is a symmetrical figure, its central symmetry point is the center point. When the microstructure 5 is an asymmetrical figure, the center of the equivalent circle with equal area after normalizing its edge is the center point.

For the first working fluid and the second working fluid, there are two types of working fluid channel sheets 1. The heat exchanger 100 includes first working fluid channel sheets 11 and second working fluid channel sheets 12 alternately stacked along the O-Z direction. The first working fluid channel sheet 11 includes first microstructures 51 and first recesses formed by stamping. The second working fluid channel sheet 12 includes second microstructures 52 and second recesses formed by stamping. The first microstructure 51 is different from the second microstructure 52. The first working fluid channel sheet 11, the first microstructures 51 and the second working fluid channel sheet 12 define the first working fluid channel. The second working fluid channel sheet 12, the second microstructure 52 and the first working fluid channel sheet 11 define and form the second working fluid channel.

Referring to FIG. 3 to FIG. 4 and FIG. 12 to FIG. 13, the stacking of the first microstructure 51 and the second microstructure 52 is illustrated. In the O-XY direction, a part of a first edge portion 511 of the first microstructure 51 exceeds the second microstructure 52, that is, a projection of the part of the first edge portion 511 on the second working fluid channel sheet 12 along the O-Z direction exceeds the second microstructure 52, and the part exceeding the second microstructure is attached to a periphery of the second recess to serve as a supporting/bonding point when the two adjacent working fluid channel sheets 1 are stacked; and/or a part of a second edge portion 521 of the second microstructure 52 exceeds the first microstructure 51, that is, a projection of the part of the second edge portion 521 on the first working fluid channel sheet 11 along the O-Z direction exceeds the first microstructure 51, and the part exceeding the first microstructure is attached to a periphery of the first recess to serve as a supporting/bonding point when the two adjacent working fluid channel sheets 1 are stacked.

Preferably, in order to ensure effective atomic diffusion bonding, an area of each part exceeding the first microstructure or the second microstructure is not smaller than 0.04 mm², preferably 0.04 mm² to 0.06 mm², for example, 0.05 mm². Considering the chamfering at the processed protrusion edge, the length of the first edge portion 511 exceeding the second microstructure 52 in the O-Y direction is not smaller than 0.15 mm; the length of the second edge portion 521 exceeding the first microstructure 51 in the O-Y direction is not smaller than 0.15 mm; and these two lengths may be the same or different.

When the first microstructure 51 and the second microstructure 52 are projected onto the same O-XY plane along the O-Z direction, the projections of the first edge portion 511 and the second edge portion 521 do not overlap, and the supporting/bonding points are dispersed in different regions. Preferably, taking a projection of the center point of the first microstructure 51 as a center of circle, the projections of the first edge portion 511 and the second edge portion 521 are uniformly disposed along a circumferential direction of the center of circle, so that the supporting/bonding force is more uniform. More preferably, the first edge portion 511 and the second edge portion 521 are at different distances from the center of circle, and are disposed in multiple layers, so as to obtain a better supporting/bonding effect.

In an embodiment, at least one and preferably two first edge portions 511 of the first microstructure 51 along the O-Y direction exceed the second microstructure 52; and at least one and preferably two second edge portions 521 of the second microstructure 52 along the O-Y direction exceed the first microstructure 51, so that supports are formed at four corners, thereby achieving higher bonding strength.

In another embodiment, a length of the first microstructure 51 along the O-Y direction is greater than a length along the O-X direction, a length of the second microstructure 52 along the O-Y direction is smaller than or equal to a length along the O-X direction, the length of the first microstructure 51 along the O-Y direction is greater than the length of the second microstructure 52 along the O-Y direction, and the length of the first microstructure 51 along the O-X direction is smaller than the length of the second microstructure 52 along the O-X direction.

For example, the first microstructure 51 is oval or gourd-shaped; the second microstructure 52 is rhombic, spindle-shaped with included angles at two ends in a longitudinal direction, or circular; both ends of the first microstructure 51 along the O-Y direction exceed the second microstructure 52; and both ends of the second microstructure 52 along the O-X direction exceed the first microstructure 51.

When the heat exchanger 100 is formed by stacking, the first working fluid channel sheets 11 and the second working fluid channel sheets 12 are alternately stacked along the O-Z direction, and the center points of the first microstructure 51 and the second microstructure 52 are aligned along the O-XY direction, so that the adjacent working fluid channel sheets 1 can support each other and be bonded with each other.

In addition, the heat exchanger 100 can be used in a variety of scenes. For example, when the heat exchanger is used as a condenser or an evaporator in a refrigeration system, the first working fluid is a high-pressure two-phase refrigerant, and the second working fluid is low-pressure single-phase water. In order to adapt to working fluids with different temperatures and/or phases and/or pressures, the first working fluid channel sheet 11 includes a first heat exchange region 41 having the first microstructures 51, and a first inlet 21 and a first outlet 31 communicating with the first heat exchange region 41. The second working fluid channel sheet 12 includes a second heat exchange region 42 having the second microstructures 52, and a second inlet 22 and a second outlet 32 communicating with the second heat exchange region 42. A side of the first microstructure 51 facing the first inlet 21 and a side of the second microstructure 52 facing the second inlet 22 have different shapes. The parts that first come into contact with the first working fluid and the second working fluid are different, and the heat exchanger is designed for different working fluids, which balances the heat exchange performance and the pressure loss.

In an embodiment, the side of the first microstructure 51 facing the first inlet 21 is arc-shaped, which makes the stamping die easier to design and high in production yield. For example, the first microstructure 51 is oval or gourd-shaped.

The side of the second microstructure 52 facing the inlet 2 is pointed with an included angle of not greater than 90°, so that the flow loss is small, and the heat exchange performance between the second working fluid and the second microstructure 52 is good based on the leading edge effect. For example, the second microstructure is rhombic, or spindle-shaped with included angles at two ends in a longitudinal direction.

The structure of the enclosure dam 6 will be described in detail below.

An inner edge 143 of the enclosure dam 6 facing the heat exchange region 4 is in contact with the working fluid, which also affects the flow of the working fluid to some extent. In the present invention, the shape of a part of the inner edge 143 is the same as the arrangement shape of a row of the microstructures 5 closest to the inner edge 143, and this edge 143 has the same turbulence trend to the working fluid as the adjacent microstructure 5.

Specifically, the shape of the inner edge 143 extending along a flow direction of the working fluid is the same as the arrangement shape of the row of the microstructures 5 close to the inner edge 143, so that the flow trend of the working fluid at the edge is substantially the same as that in the middle region. The flow direction of the working fluid is not the actual flow direction, but is from the side where the inlet 2 is disposed to the side where the outlet 3 is disposed. Preferably, the inner edge 143 extending along the flow direction of the working fluid has the same distance from the row of the microstructures 5 close to the inner edge. Different regions have the same turbulence trend to the working fluid.

The inlet 2 and the outlet 3 are respectively disposed two opposite sides of the enclosure dam 6. The shape of the inner edge 143 on the side where the inlet 2 is located is the same as the arrangement shape of the row of the microstructures 5 closest to the inner edge, and the inner edge is equivalent to a row of the microstructures 5 upstream of the closest row of the microstructures 5. The thrust and resistance to the working fluid in the forward direction of the working fluid are similar, so that the working fluid is prevented from rebounding greatly at the edge of the heat exchange region 4, causing greater flow loss. Preferably, the inner edge 143 on the side where the inlet 2 is located has the same distance from the row of the microstructures 5 closest to the inner edge 143, and different regions have the same turbulence trend to the working fluid.

And/or, the shape of the inner edge 143 on the side where the outlet 3 is located is the same as the arrangement shape of the row of the microstructures 5 closest to the inner edge 143, and this inner edge is equivalent to a row of the microstructures 5 downstream of the closest row of the microstructures 5. The thrust and resistance to the working fluid in the forward direction of the working fluid are similar, so that the working fluid is prevented from rebounding greatly at the edge of the heat exchange region 4, causing greater flow loss. Preferably, the inner edge 143 on the side where the outlet 3 is located is the same as the distance from the row of the microstructures 5 closest to the inner edge 143, and different regions have the same turbulence trend to the working fluid.

In a specific embodiment, the inlet 2 and the outlet 3 are respectively disposed on two sides of the enclosure dam 6 along the O-Y direction. The plurality of microstructures 5 are distributed along a plurality of sine curves extending along the O-X direction, and the microstructures 5 on the adjacent sine curves are disposed in a staggered manner along an extending direction of the sine curve. The row of the microstructures 5 along the flow direction of the working fluid and located on the edge are wave-shaped. The inner edges 143 on two sides of the enclosure dam 6 along the O-Y direction are also sine curve-shaped, and the inner edge 143 extending along the flow direction of the working fluid is wave-shaped.

Further, a gap between each inner edge 143 and the microstructure 5 is the same as a gap between the adjacent microstructures 5 in the same direction, and the two gaps also have the same turbulence effect on the working fluid.

The distribution of the inlets 2 and the outlets 3 on two working fluid channel sheets will be described below.

On one working fluid channel sheet 1, the inlet 2 and the outlet 3 are respectively disposed on two sides along the O-Y direction, and disposed in a staggered manner along the O-X direction, that is, the inlet 2 and the outlet 3 are disposed diagonally, so that the working fluid has a long circulating distance, which improves the heat exchange performance.

Preferably, the first inlet 21 and the second outlet 32 are located at one side of the heat exchanger 100, and the first outlet 31 and the second inlet 22 are located at the other side of the heat exchanger 100. Therefore, all the inlets 2 and the outlets 3 are respectively arranged on the two opposite sides of the heat exchanger 100, which facilitates the subsequent process such as external connection of inlet and outlet ducts, and makes the structure more compact and the size smaller.

Preferably, the first inlet 21 and the second outlet 32 are disposed in parallel along the O-X direction. The second inlet 22 and the first outlet 31 are disposed in parallel along the O-X direction. Therefore, the first inlet 21 and the first outlet 31 are disposed diagonally, and the second inlet 22 and the second outlet 32 are disposed diagonally, so that the first working fluid and the second working fluid substantially flow in opposite directions, which has a good heat exchange effect.

When the heat exchanger 100 is used as a condenser, the first working fluid is a gas/liquid two-phase high-pressure refrigerant having a large temperature difference from the working fluid channel sheet 1, and the second working fluid is low-pressure water. In an embodiment, along the O-X direction, a width of the second outlet 32 is greater than a width of the first inlet 21, and a width of the second inlet 22 is greater than a width of the first outlet 31, thereby ensuring the flow rate of water and the temperature of water after heat exchange. In another embodiment, the first inlet 21 and the first outlet 32 have different widths, the gaseous refrigerant with higher pressure enters from the wider first inlet 21, and the liquid refrigerant flows out from the narrower first outlet 32, which ensures the pressure balance in the whole flow process. The second inlet 22 and the second outlet 32 have the same width, thereby ensuring a stable flow of the water. When the heat exchanger 100 is used as an evaporator, the first inlet and the first outlet are used in reverse.

The working fluid channel sheet 1 will be further described below in detail in conjunction with the manufacturing process.

When the working fluid channel sheet 1 is integrated, only a physical/chemical etching process is suitable for forming the microstructures 5 and the enclosure dam 6 on a thick sheet, and a stamping process is not applicable.

Referring to FIG. 1 to FIG. 17, the working fluid channel sheet 1 is designed as a split type, which includes a microstructure sheet 13 and a microstructure sheet gasket 14 (hereinafter referred to as a gasket) stacked along the O-Z direction. Specifically, the first working fluid channel sheet 11 includes a first microstructure sheet 131 and a first microstructure sheet gasket 141 (hereinafter referred to as a first gasket 141). The second working fluid channel sheet 12 includes a second microstructure sheet 132 and a second microstructure sheet gasket 142 (hereinafter referred to as a second gasket 142). The first microstructure sheet 131 and the second microstructure sheet 132 are collectively referred to as the microstructure sheets 13, and the first gasket 141 and the second gasket 142 are collectively referred to as the gaskets 14.

Along the O-Z direction, a shape of the microstructure sheet 13 is the same as that of the working fluid channel sheet 1, and the microstructure sheet 13 includes the heat exchange region 4 and an edge region disposed around the heat exchange region 4. The gasket 14 has the same shape as the edge region, the gasket 14 is disposed on the edge region at the side where the microstructures 5 are disposed, and the enclosure dam 6 is formed on a periphery of the heat exchange region 4. All the descriptions of the enclosure dam 6 are applicable to the gasket 14.

In the present invention, the working fluid channel sheet 1 is divided into two parts along the O-Z direction, and the microstructures 5 are disposed on the microstructure sheet 13; the microstructure sheet 13 and the gasket 14 may be respectively formed by adopting a stamping, process and then stacked, and the enclosure dam 6 is formed by the gasket 14; and therefore, there are no recesses on the other side corresponding the enclosure dam 6, and the two can be bonded together by atomic diffusion bonding. Compared with the traditional photoetching process, the present invention is low in production cost, suitable for mass production and low in environmental pollution.

The smaller the thicknesses of the microstructure sheet 13 and the gasket 14, the lighter the weight, the smaller the thermal resistance and the better the heat exchange performance of the heat exchanger 100 finally formed. Based on the sheet and performance thereof, and the limitations of the stamping process at present, the thicknesses of the microstructure sheet 13 and the gasket 14 are 0.07-0.1 mm, for example, 0.1 mm, 0.09 mm, 0.08 mm. 0.075 mm or 0.07 mm. Preferably, the thicknesses are below 0.1 mm, which makes the thermal resistance small. However, this poses a huge challenge to the process.

The microstructures 5 formed in the heat exchange region 4 of the microstructure sheet 13 by stamping are hollow protrusions, and gaps between the plurality of microstructures communicate to form the microchannels, so that the fluid is divided into a plurality of small flows for heat exchange, which improves the heat exchange performance.

The larger the thickness of the microstructure sheet 13, the larger the diameter of the microstructure 5, the higher the strength, the smaller the pitch between the adjacent microstructures 5, the higher the pressure resistance of the microstructure sheet 13 to the first working fluid and the second working fluid located at its two sides; and on the contrary; the lower the pressure resistance. The thickness of the microstructure sheet 13 depends on the thickness of the sheet. The height of the microstructure 5 is not smaller than, preferably consistent with, the thickness of the gasket 14. When the microstructure sheet and the gasket are stacked and pressed, the slightly higher microstructure 5 can deform slightly so as to ensure the microstructure 5 to effectively contact the adjacent microstructure sheet 13, which is a necessary condition for atomic diffusion bonding. Specifically, the thickness of the gasket 14 is smaller than or equal to the thickness of the microstructure sheet 13, and the height of the microstructure is adaptively adjusted with the thickness of the gasket 14. In the present invention, the thickness of the gasket 14 is consistent with that of the microstructure sheet 13, and are respectively formed by the same type of sheet.

Considering the performance of the stamping die and the microstructure sheet, the microstructures 5 have an equivalent diameter of not greater than 0.7 mm, preferably not smaller than 0.5 mm. The pitch between every two adjacent microstructures 5 is 0.5-2.5 mm, preferably 1-1.5 mm.

The gasket 14 forms the enclosure dam 6 of the working fluid channel around the periphery of the heat exchange region 4. The width of the gasket 14 is designed according to the pressure resistance of the heat exchanger 100 and the atomic diffusion bonding process, and is, for example, 2.5-5 mm, preferably 3 mm.

An outer contour of the gasket 14 is the same as the shape of the heat exchanger 100, and the inner edge 143 facing the heat exchange region 4 is in contact with the working fluid, specifically referring to the inner edge 143 of the enclosure dam 6.

In addition, no matter of whether the working fluid channel sheet is a split or integrated structure, regions around the inlet 2 and the outlet 3 on the working fluid channel sheet 1 have guide surfaces 10 for guiding the working fluid. The guide surface 10 is inclined or stepped in shape, so that when the fluid, such as the coolant or water, is guided into the heat exchange region 4, what the fluid faces is not a “wall”, but a plurality of inlets with the guide surface 10. In the split structure, the guide surface 10 is formed by the microstructure sheet and the microstructure sheet gasket. For example, the edge is uneven, and the inner and outer layers are uneven so as to form the stepped guide surface 10.

Preferably, the guide surface 10 is located between the inlet 2 and the heat exchange region 4, or between the outlet 3 and the heat exchange region 4.

Alternatively preferably, an arc angle at a side of the inlet 2 and the outlet 3 facing the heat exchange region 4 is smaller than an arc angle at a side facing away from the heat exchange region 4, so as to facilitate the formation of the guide surface 10.

The design of the present invention will be described in detail below with reference to FIG. 1 to FIG. 11.

The first working fluid channel sheet 11 and the second working fluid channel sheet 12 include the heat exchange regions 4, two sets of inlets 2 and outlets 3 disposed around the heat exchange regions 4, and enclosure frames 15. The inlet and the outlet are all through along a thickness direction of the microstructure sheet 13.

The heat exchange region 4 is provided with the plurality of microstructures 5. The structure and arrangement of the microstructures 5 are as described above and will not be repeated here. One set of the inlet 2 and outlet 3 communicate with the heat exchange region 4. The other set of the inlet 2 and outlet 3 are isolated from the heat exchange region 4 through an enclosure baffle 16, so that the working fluid entering from this inlet 2 cannot enter the heat exchange region 4.

The two sets of inlets 2 and outlets 3 will be described in an example where the first inlet 21 and the first outlet 31 of the first working fluid channel sheet 11 communicate with the heat exchange region 4 and the second inlet 22 and the second outlet 32 are isolated from the heat exchange region 4 through the enclosure baffle 16.

The first inlet 21 and the first outlet 31 communicating with the heat exchange region 4 have small distances from the row of the microstructures 5 closest thereto, which are equivalent to the distance between the adjacent microstructures 5 in this direction. Regions close to the first inlet 21 and the first outlet 31 are provided with the microstructures 5 so as to uniformly support the adjacent microstructure sheet 13, form sufficient bonding strength after atomic diffusion bonding and also ensure the smooth passage of the first working fluid.

The second inlet 22 and the second outlet 32 isolated from the heat exchange region 4 are isolated from the heat exchange region 4 by the enclosure baffle 16. In order to ensure the isolation effect, the second inlet 22 and the second outlet 32 have large distances from the row of the microstructures 5 closest thereto, which are greater than the distance between the adjacent microstructures 5 in this direction.

Specifically, the distances from the first inlet 21 and the first outlet 31 to the row of the microstructures 5 closest thereto are respectively L1, and the distances from the second inlet 22 and the second outlet 32 to the row of the microstructures 5 closest thereto are respectively L2. L1 is smaller than L2. A width of the enclosure baffle 16 is smaller than or equal to L2.

In an embodiment, in the arrangement direction of the first inlet 21 and the first outlet 31, and the row of the microstructures 5 respectively closest thereto, L1 is smaller than or equal to the distance between the adjacent microstructures 5, so that the supporting/bonding strength at the inlet/outlet is high; and/or in the arrangement direction of the second inlet 22 and the second outlet 32, and the row of the microstructures 5 respectively closest thereto, L2 is greater than the distance between the adjacent microstructures 5, thereby ensuring effective isolation.

Further, L2 is 1.5-4 times, for example, 2 times or 3 times, the distance between the two adjacent rows of the microstructures 5.

In another embodiment, the first inlet 21 and the first outlet 31 are respectively disposed on two sides of the heat exchange region 4 along the O-Y direction, and the second inlet 22 and the second outlet 32 are respectively disposed on two sides of the heat exchange region 4 along the O-Y direction. The plurality of microstructures 5 are distributed along a plurality of sine curves extending along the O-X direction. The plurality of sine curves are disposed at intervals along the O-Y direction.

Preferably, L1 is smaller than or equal to a distance between the two adjacent sine curves; and/or L2 is greater than or equal to 1.5-4 times, for example, 2 times or 3 times, the distance between the two adjacent sine curves, and this width can accommodate 1 or 2 or 3 sine curves.

In addition, the sizes of the inlet 2 and the outlet 3 are usually set according to the pressure and flow rate of the working fluid. In the present invention, the first inlet 21 and the first outlet 31 are respectively disposed on two sides of the heat exchange region 4 along the O-Y direction, and the second inlet 22 and the second outlet 32 are also respectively disposed on two sides of the heat exchange region 4 along the O-Y direction. Moreover, along the O-X direction, the widths of the first inlet 21 and the first outlet 31 are smaller than the widths of the second inlet 22 and the second outlet 32. In this way, when the first working fluid is a refrigerant and the second working fluid is water, the heat exchange performance and the pressure loss are optimal.

Specifically, in the O-X direction, the widths of the second inlet 22 and the second outlet 32 are greater than ½ of the width of the heat exchange region 4. The outlet 3 of the second working fluid has a large lateral width. The larger the width, the more the second working fluid tends to pass through the heat exchange region 4 in a straight line, and the smaller the pressure loss.

Preferably, the widths of the second inlet 22 and the second outlet 32 are ½ to ⅘, for example, ⅔ or ¾, of the width of the heat exchange region 4. The second working fluid channel is similar to a centerline straight-through structure, so that the flow loss is small.

In a specific embodiment, the first inlet 21 and the second outlet 32 are located at one side of the heat exchange region 4 along the O-Y direction and arranged along the O-X direction. The first outlet 31 and the second inlet 22 are located at the other side of the heat exchange region 4 along the O-Y direction and arranged along the O-X direction. Preferably, in the O-X direction, the first inlet 21 and the first outlet 31 are disposed in a staggered manner, and the second inlet 22 and the second outlet 32 are disposed in a staggered manner, so that the first working fluid and the second working fluid flow in opposite directions, which improves the heat exchange performance.

In another embodiment, the width of the first inlet 21 is greater than the width of the first outlet 31, and the width of the second outlet 32 is smaller than the width of the first outlet 31, which is applicable to a condenser in which the first inlet 21 communicates with a compressor.

Preferably, the enclosure baffle 16 and the enclosure frame 15 have the same width to ensure high bonding strength everywhere, and also have the same pressure bearing capacity for the working fluid to avoid the leakage of the working fluid. The rest regions are distributed by the inlet 2 and the outlet 3 on the same side.

Further, in order to be able to adopt the stamping process, the working fluid channel sheet 1 includes the microstructure sheet 13 and the microstructure sheet gasket 14 stacked along the O-Z direction.

The microstructure sheet 13 includes the heat exchange region 4, a first inlet through hole 21′, a first outlet through hole 31′, a second inlet through hole 22′, a second outlet through hole 32′ and a first enclosure frame corresponding to the enclosure frame 15. The first inlet through hole 21′, the first outlet through hole 31′, the second inlet through hole 22′ and the second outlet through hole 32′ all run through the microstructure sheet 13 along a thickness direction.

In order to adapt to different working fluids, the microstructure sheet 13 includes the first microstructure sheet 131 and the second microstructure sheet 132. The microstructure sheet 13 and the gasket 14 have the same outer contour, for example, they are both square, which can save the sheet material most.

The first microstructure sheet 131 includes the first heat exchange region 41, the first inlet through hole 21′ and the second outlet through hole 32′ disposed on one side of the first heat exchange region 41 along the O-Y direction and arranged along the O-X direction, the first outlet through hole 31′ and the second inlet through hole 22′ disposed on the other side of the first heat exchange region 41 along the O-Y direction and arranged along the O-X direction, and the first enclosure frame. The first inlet through hole 21′, the second outlet through hole 32′, the first outlet through hole 31′, the second inlet through hole 22′ and the first enclosure frame are located in the edge region. Moreover, the first inlet through hole 21′ and the first outlet through hole 31′ communicate with the first heat exchange region 41, and the second inlet through hole 22′ and the second outlet through hole 32′ are isolated from the first heat exchange region 41 through the enclosure baffle 16.

The second microstructure sheet 132 includes the second heat exchange region 42, the first inlet through hole 21′ and the second outlet through hole 32′ disposed on one side of the second heat exchange region 42 along the O-Y direction and arranged along the O-X direction, the first outlet through hole 31′ and the second inlet through hole 22′ disposed on the other side of the second heat exchange region 42 along the O-Y direction and arranged along the O-X direction, and the first enclosure frame. The first inlet through hole 21′, the second outlet through hole 32′, the first outlet through hole 31′, the second inlet through hole 22′ and the first enclosure frame are disposed in the edge region. The second microstructure sheet is different from the first microstructure sheet 131 in that: the first inlet through hole 21′ and the first outlet through hole 31′ are isolated from the first heat exchange region 41 through the enclosure baffle 16, and the second inlet through hole 22′ and the second outlet through hole 32′ communicate with the first heat exchange region 41.

Specifically, the first inlet through hole 21′ and the first outlet through hole 31′ isolated from the second heat exchange region 42 have a distance L1 from the row of the microstructures 5 closest thereto, and the second inlet through hole 22′ and the second outlet through hole 32′ communicating with the second heat exchange region 42 have a distance L2 from the row of the microstructures 5 closest thereto. L1 is greater than L2. Further, L1 is greater than the distance between the adjacent microstructures 5 in this direction; and/or L2 is smaller than or equal to the distance between the adjacent microstructures 5 in this direction. Preferably, L1 is 1.5-4 times, for example, 2 times or 3 times, the distance between the two adjacent rows of the microstructures 5 in this direction. Alternatively, L1 is greater than or equal to 1.5-4 times the distance between the two adjacent sine curves, and the width L2 can accommodate one or two sine curves; and/or L2 is smaller than or equal to the distance between the two adjacent sine curves.

The gasket 14 includes: a heat exchange hollow region 144 corresponding to the heat exchange region 4 and the inlet through hole 2′ and the outlet through hole 3′ communicating with the heat exchange region 4, an inlet hollow region 145 corresponding to the inlet through hole 2′ isolated from the heat exchange region 4, an outlet hollow region 146 corresponding to the outlet through hole 3′ isolated from the heat exchange region 4, the enclosure baffle 16, and a second enclosure frame corresponding to the enclosure frame 15.

The part of the heat exchange hollow region 144 corresponding to the inlet through hole 2′ is called the inlet 2, and the part of the heat exchange hollow region corresponding to the outlet through hole 3′ is called the outlet 3. In order to simplify the description, the inlet through hole 2′ may also be called the inlet, and the outlet through hole 3′ may also be called the outlet.

The heat exchange hollow region 144, the inlet hollow region 145 and the outlet hollow region 146 are all through along the thickness direction of the gasket 14. The enclosure baffle 16 is located between the inlet hollow region 145 and the heat exchange hollow region 144, and between the outlet hollow region 146 and the heat exchange hollow region 144. The second enclosure frame encloses these hollow regions together, so that the gasket is integrated as a whole. After stacking, the first enclosure frame and the second enclosure frame form the enclosure frame 15.

The method of forming the inner edge 143 of the heat exchange hollow region 144 on the gasket 14 is the same as the description above. The shape of the inner edge is the same as the arrangement shape of the row of the microstructures 5 closest thereto, and preferably the inner edge has the same distance from the row of the microstructures 5 closest thereto, and more preferably has the same distance from adjacent rows of the microstructures 5 in the same direction.

Specifically, the gasket 14 includes the first gasket 141 matched with the first microstructure sheet 131, and the second gasket 142 matched with the second microstructure sheet 132.

The first gasket 141 includes a first heat exchange hollow region corresponding to the first heat exchange region 41, the first inlet through hole 21′ and the first outlet through hole 31′, a second inlet hollow region corresponding to the second inlet through hole 22′, a second outlet hollow region corresponding to the second outlet through hole 32′, and the second enclosure frame corresponding to the enclosure frame 15.

The second gasket 142 includes a second heat exchange hollow region corresponding to the second heat exchange region 42, the second inlet through hole 22′ and the second outlet through hole 32′, a first inlet hollow region corresponding to the first inlet through hole 21′, a first outlet hollow region corresponding to the first outlet through hole 31′, and the second enclosure frame corresponding to the enclosure frame 15.

The present invention further uses an external base sheet 71 as a base sheet and an external working fluid inlet/outlet sheet 72 as a cover, which have a thickness of 2-3 mm and have high pressure bearing capacity to protect the internal working fluid channel sheets 1.

The method for manufacturing a heat exchanger generally includes stacking and atomic diffusion.

The method for manufacturing a heat exchanger includes: forming a plurality of first working fluid channel sheets 11; forming a plurality of second working fluid channel sheets 12; after cleaning, stacking the first working fluid channel sheets 11 and the second working fluid channel sheets 12 alternately between an external base sheet 71 and an external working fluid inlet/outlet sheet 72 along an O-Z direction; and pressing the sheets by a tool clamp to perform atomic diffusion bonding.

Specifically, the method for manufacturing a heat exchanger includes: forming first microstructure sheets 131, first gaskets 141, second microstructure sheets 132 and second gaskets 142 by stamping; and after cleaning, stacking at least one repeating unit according to a sequence of the first microstructure sheet 131, the first gasket 141, the second microstructure sheet 132 and the second gasket 142 on an external base sheet 71 to a set height, placing an external working fluid inlet/outlet sheet 72 as a cover, and pressing the sheets by a tool clamp. The number of the repeating units may be an integer, or ¼, or 2/4 or ¾ more than an integer.

The atomic diffusion bonding in all the embodiments here is completed in a vacuum oven under a vacuum pressure of 4×10⁻³ Pa and an applied surface pressure of 5 MPa at a temperature of about 1100° C. After the atomic diffusion bonding, the body of the heat exchanger 100 is completed.

After stacking, a plurality of first inlet through holes 21′, a plurality of first heat exchange hollow regions 144 and a plurality of first inlet hollow regions form a first inflow chamber 81, a plurality of second outlet through holes 32′, a plurality of first heat exchange hollow regions 144 and a plurality of first outlet hollow regions form a first outflow chamber 83. Then, a first inflow tube 82 or a first inflow tube joint communicating with the first inflow chamber 81, and a first outflow tube 84 or a first outflow tube joint communicating with the first outflow chamber 83 are connected to the external working fluid inlet/outlet sheet 72. A first working fluid enters the first inflow chamber 81 so as to be buffered and mixed, enters the first working fluid channel via a plurality of first inlets 21, flows to the first outflow chamber 83 and then flows out.

An extending direction of the first inflow tube 82 or the first inflow tube joint intersects with, preferably is perpendicular to, an arrangement direction of the first inlets 21 and the first heat exchange regions 41, that is, a direction in which the first working fluid flows into the first inflow chamber 81 through the first inflow tube 82 or the first inflow tube joint intersects with, preferably is perpendicular to, a direction in which the first working fluid flows into the first heat exchange regions 41 through the first inlets 21, which is suitable for the high-pressure two-phase first working fluid, for example, a refrigerant. After entering the first inflow chamber 81, the first working fluid can enter the first working fluid channel only after bending, which increases the mixing uniformity under the impact force. This avoids gas-liquid separation, causing only the gaseous working fluid in a part of the first working fluid channel and thus leading to poor heat exchange performance.

A plurality of second inlet through holes 22′, a plurality of second heat exchange hollow regions 144 and a plurality of second inlet hollow regions form a second inflow chamber 85, and a plurality of second outlet through holes 32′, a plurality of second heat exchange hollow regions 144 and a plurality of second outlet hollow regions form a second outflow chamber 87. A first enclosure frame and a second enclosure frame form an enclosure wall. Then, a second inflow tube or a second inflow tube joint 86 communicating with the second inflow chamber 85, and a second outflow tube or a second outflow tube joint 88 communicating with the second outflow chamber 87 are connected to the enclosure wall. A second working fluid enters the second inflow chamber 85 to be buffered and mixed, enters the second working fluid channel via a plurality of second inlets 22, flows to the second outflow chamber 87, and then flows out.

Preferably, an extending direction of the second inflow tube or the second inflow tube joint 86 is the same as an arrangement direction of the second inlets 22 and the second heat exchange regions 42, which is suitable for the low-pressure single-phase second working fluid, for example, water. The second working fluid enters the second inflow chamber 85 to be buffered and distributed, enters the plurality of second working fluid channels, which produces small pressure loss due to the same flow direction.

Specifically, a computer numerical control machine cuts the enclosure wall to form a through connection port communicating with the second inflow chamber 85, and the second inflow tube or the second inflow tube joint 86 is welded to the connection port. Compared with the first embodiment, external welding of a first inflow cover sheet, a first outflow cover sheet, a second inflow cover sheet and a second outflow cover sheet is omitted, which improves the reliability. FIG. 17 illustrates a region A where the inlet or outlet is formed by machine cutting.

The first inflow tube 82 or the first inflow tube joint, the first outflow tube 84 or the first outflow tube joint, the second inflow tube or the second inflow tube joint 86, and the second outflow tube or the second outflow tube joint 88 are bonded to the body of the heat exchanger 100 by atomic diffusion and then welding, the sequence of which can reversed.

The method for manufacturing a heat exchanger further includes: forming first microstructures 51 in the first heat exchange region 41 by stamping; and forming second microstructures 52 in the second heat exchange region 42 by stamping. The first microstructure 51 and the second microstructure 52 described above have different shapes. When stacking along the O-Z direction, center points of the first microstructures 51 and the second microstructures 52 are aligned along the O-XY direction, which can ensure the adjacent working fluid channel sheets 1 to be supported each other and bonded with each other. Other details are the same as above and will not be repeated here.

In addition, based on the fact the microstructure sheet 13 and the gasket 14 have the same outer contour, the present invention adopts the following method, including: forming at least two stamping sheets respectively on a plurality of first sheets, a plurality of second sheets, a plurality of third sheets and a plurality of fourth sheets according to a same arrangement, the stamping sheet on the first sheet including at least one of the first microstructure sheet 131, the first gasket 141, the second microstructure sheet 132 and the second gasket 142, and the stamping sheets at corresponding positions in the first sheets, the second sheets, the third sheets and the fourth sheets being disposed according to a loop sequence of the first microstructure sheet 131, the first gasket 141, the second microstructure sheet 132, the second microstructure sheet 132 and the first microstructure sheet 131; stacking at least one repeating unit between the external base sheet 71 and the external working fluid inlet/outlet sheet 72 according to a sequence of the first sheet, the second sheet, the third sheet and the fourth sheet; and then carrying out atomic diffusion bonding, and carrying out cutting between every two adjacent stamping sheets to form a plurality of heat exchangers 100.

According to this method, a plurality of compact heat exchangers 4 can be formed at the same time, which improves the production efficiency. Moreover, it is only required to form a locating structure or a fool-proof structure or a locating and fool-proof structure in the edge or middle region of the first sheet, the second sheet, the third sheet and the fourth sheet, and there is no need to form a locating structure on each stamping sheet, which saves the material of the stamping sheets.

Preferably, as shown in FIG. 11, the plurality of stamping sheets on the first sheets are of the same type, the plurality of miniature heat exchangers 100 formed are completely the same, and the stamping sheets on the same sheet have the same shape, which facilitates production and inspection. For example, a plurality of first microstructure sheets 131 are formed on the first sheet by stamping, the same number of first microstructure sheets 131 with the same arrangement are formed on the second sheet by stamping, and the same number of second microstructure sheets 132 with the same arrangement are formed on the third sheet by stamping. The same number of second gaskets 142 with the same arrangement are formed on the fourth sheet.

Of course, the plurality of stamping sheets on the first sheet may also include at least two types of stamping sheets, so that the stress of the entire sheet is more balanced.

In addition, according to the size of the sheet, the number of the stamping sheets formed on the first sheet is 2, or 4, or 6, or 8.

In addition, on the basis of the above preparation method, further, the gaskets 14 adjacent to the external base sheet 71 and the external working fluid inlet/outlet sheet 72 are of the same type, and the fluids on two sides of the heat exchanger 100 along the stacking direction are of the same fluid. Thus, when the heat exchanger 100 is put into use, the working fluid that actively provides cold or heat energy passes through the working fluid channel adjacent to the external base sheet 71 and the external working fluid inlet/outlet sheet 72, and the other fluid that passively acquires energy is surrounded by the fluid that actively provides energy, that is, the working fluid that passively acquires energy can acquire energy from the fluid that actively provides energy from both sides, so that the heat exchange performance is good.

For example, when the heat exchanger 100 is used as a condenser or an evaporator, the first working fluid is a refrigerant, and the second working fluid is water. All that are adjacent to the external base sheet 71 and the external working fluid inlet/outlet sheet 72 are the first gaskets 141, the refrigerant surrounds the water, and any water flow layer can exchange heat with the refrigerant from both sides, so that the heat exchange performance is good.

Referring to FIG. 12 to FIG. 17, the second embodiment of the present invention is different from the first embodiment only in that:

The first inlet 21, the first outlet 31, the second inlet 22 and the second outlet 32 have slightly different shapes, and one side thereof facing the heat exchange region 4 is smoother than the other sides, which facilitates the formation of the guide surface 10.

The first microstructure sheet 131, the first gasket 141, the second microstructure sheet 132 and the second gasket 142 are respectively provided with locating holes 9, and preferably, the locating holes are disposed at four corners, which facilitates the stacking and does not affect the arrangement of the body of the heat exchange region.

The present invention further provides a heat exchanger 100, which is formed by stacking any of the working fluid channel sheets 1 above or prepared by any of the methods for manufacturing a heat exchanger above. The heat exchanger 100 includes a plurality of working fluid channel sheets 1 described above. The plurality of working fluid channel sheets 1 are stacked along the O-Z direction. A working fluid channel for a working fluid to circulate is formed between every two adjacent working fluid channel sheets 1. One of the two adjacent working fluid channels communicates only with the first inlet 21 and the first outlet 31, and the other communicates only with the second inlet 22 and the second outlet 32.

The shape and arrangement of the microstructures 5 on the adjacent working fluid channel sheets 1 are both the same as those in the first embodiment. Center points of the microstructures 5 on the adjacent working fluid channel sheets 1 are aligned along the O-XY direction, and the microstructures 5 on the adjacent working fluid channel sheets 1 have different shapes. The other details will not be repeated here.

It should be noted that in the present invention, all the features on the first working fluid channel sheet 11 are called “first”, and all the features on the second working fluid channel sheet 12 are called “second”; and “first” and “second” are only for distinguishing purposes and are not intended to limit their structures or functions. For example, the description of the heat exchange region 4 is applicable to the first heat exchange region 41 and the second heat exchange region 42; and the description of the structure and distribution of the microstructure 5 is also applicable to the first microstructure 51 and the second microstructure 52. Others examples will not be listed one by one.

It should be understood that although this specification is described according to the implementations, not every implementation contains only one independent technical solution, and this specification described in such a manner is only for the sake of clarity. Those skilled in the art should take the specification as a whole, and the technical solutions in various implementations can also be appropriately combined to form other implementations that can be understood by those skilled in the art.

The series of detailed descriptions listed above are only specific descriptions of feasible implementations of the present invention, and they are not intended to limit the protection scope of the present invention. Any equivalent implementation or change that does not depart from the technical spirit of the present invention shall fall within the protection scope of the present invention.

1. A heat exchanger, comprising a plurality of working fluid channel sheets stacked along an O-Z direction, wherein the working fluid channel sheet comprise an inlet, an outlet and a heat exchange region located between the inlet and the outlet; the heat exchange region is provided with a plurality of microstructures formed by stamping; center points of the microstructures on the adjacent working fluid channel sheets are aligned along an O-XY direction; and the microstructures on the adjacent working fluid channel sheets have different shapes.

2. The heat exchanger according to claim 1, wherein the working fluid channel sheets comprise a plurality of first working fluid channel sheets and a plurality of second working fluid channel sheets alternately stacked, and the microstructures comprise first microstructures disposed on the first working fluid channel sheets and second microstructures disposed on the second working fluid channel sheets; and in the O-XY direction, a part of a first edge portion of the first microstructure exceeds the second microstructure, and/or a part of a second edge portion of the second microstructure exceeds the first microstructure.

3. The heat exchanger according to claim 2, wherein projections of the first edge portion and the second edge portion in the O-XY plane along the O-Z direction do not overlap.

4. The heat exchanger according to claim 3, wherein taking a projection of the center point of the first microstructure in the O-XY plane along the O-Z direction as a center of circle, the projections of the first edge portion and the second edge portion are disposed at intervals along a circumferential direction of the center of circle.

5. The heat exchanger according to claim 2, wherein the first microstructure comprises at least one first edge portion exceeding the second microstructure along an O-Y direction, and the second microstructure comprises at least one second edge portion exceeding the first microstructure along an O-X direction;
alternatively, a length of the first microstructure along the O-Y direction is greater than a length along the O-X direction, a length of the second microstructure along the O-Y direction is smaller than or equal to a length along the O-X direction, the length of the first microstructure along the O-Y direction is greater than the length of the second microstructure along the O-Y direction, and the length of the first microstructure along the O-X direction is smaller than the length of the second microstructure along the O-X direction.

6. The heat exchanger according to claim 5, wherein the first microstructure is oval or gourd-shaped, and the second microstructure is rhombic, spindle-shaped with included angles at two ends in a longitudinal direction, or circular.

7. The heat exchanger according to claim 6, wherein both ends of the first microstructure along the O-Y direction exceed the second microstructure, and both ends of the second microstructure along the O-X direction exceed the first microstructure.

8. The heat exchanger according to claim 1, wherein the heat exchange region comprises a turbulent region and transition regions located on two sides of the turbulent region along a direction from a side where the inlet is located to a side where the outlet is located, a density of the microstructures disposed in the turbulent region is greater than a density of the microstructures disposed in the transition region; in the direction from the side where the inlet is located to the side where the outlet is located, a width of the turbulent region is not greater than 3 mm; or the plurality of microstructures are arranged at intervals along a plurality of sine curves, and the plurality of sine curves are arranged at intervals from the side where the inlet is located to the side where the outlet is located; and a number of the sine curves located in the turbulent region is not greater than 3.

9. The heat exchanger according to claim 8, wherein a number of the microstructures distributed on any sine curve in the transition region is smaller than a number of the microstructures on any sine curve in the turbulent region; and/or
a pitch between every two adjacent sine curves in the transition region is greater than a pitch between every two adjacent sine curves in the turbulent region.

10. The heat exchanger according to claim 1, wherein the working fluid channel sheets comprise a plurality of first working fluid channel sheets and a plurality of second working fluid channel sheets stacked alternately along the O-Z direction; the first working fluid channel sheets each comprise a first inlet, a first outlet and a first heat exchange region located between the first inlet and the first outlet, the first heat exchange region is provided with a plurality of first microstructures; and the second working fluid channel sheets each comprise a second inlet, a second outlet and a second heat exchange region located between the second inlet and the second outlet, the second heat exchange region is provided with a plurality of second microstructures; and
wherein a side of the first microstructure facing the first inlet and a side of the second microstructure facing the second inlet have different shapes.

11. The heat exchanger according to claim 10, wherein the side of the first microstructure facing the first inlet is arc-shaped, and the side of the second microstructure facing the second inlet is pointed.

12. The heat exchanger according to claim 11, wherein the heat exchanger further comprises a first inflow chamber communicating with a plurality of first inlets, and a first inflow tube or a first inflow tube joint communicating with the first inflow chamber, an extending direction of the first inflow tube or the first inflow tube joint intersects with an arrangement direction of the first inlets and the first heat exchange regions; and
the heat exchanger further comprises a second inflow chamber communicating with a plurality of second inlets, and a second inflow tube or a second inflow tube joint communicating with the second inflow chamber, an extending direction of the second inflow tube or the second inflow tube is the same as an arrangement direction of the second inlets and the second heat exchange regions.

13. A method for manufacturing a heat exchanger, comprising the following steps:
forming first working fluid channel sheets, the first working fluid channel sheets each comprising a first inlet, a first outlet and a first heat exchange region located between the first inlet and the second inlet, and the first heat exchange region having a plurality of first microstructures formed by stamping;
forming second working fluid channel sheets, the second working fluid channel sheets each comprising a second inlet, a second outlet and a second heat exchange region located between the second inlet and the second outlet, the second heat exchange region having a plurality of second microstructures formed by stamping, and the first microstructures and the second microstructures having different shapes;
stacking the first working fluid channel sheets and the second working fluid channel sheets alternately along an O-Z direction, center points of the first microstructures and the second microstructures being aligned along an O-XY direction, the plurality of first inlets being aligned along the O-XY direction, the plurality of second inlets being aligned along the O-XY direction, and the plurality of first inlets, the plurality of first outlets, the plurality of second inlets and the plurality of second outlets being disposed in a staggered manner; and
bonding the first working fluid channel sheets and the second working fluid channel sheets stacked together by atomic diffusion.

14. The method for manufacturing a heat exchanger according to claim 13, wherein in the O-XY extending direction, a part of a first edge portion of the first microstructure exceeds the second microstructure, and/or a part of a second edge portion of the second microstructure exceeds the first microstructure.

15. The method for manufacturing a heat exchanger according to claim 13, wherein projections of the first edge portion and the second edge portion in the O-XY plane along the O-Z direction do not overlap; or
taking a projection of the center point of the first microstructure in the O-XY plane along the O-Z direction as a center of circle, the projections of the first edge portion and the second edge portion are disposed in a staggered manner along a circumferential direction of the center of circle; or
at least one edge of the first microstructure along the O-Y direction exceeds the second microstructure, and at least one edge of the second microstructure along the O-X direction exceeds the first microstructure; or
a length of the first microstructure along the O-Y direction is greater than a length along the O-X direction, a length of the second microstructure along the O-Y direction is smaller than or equal to a length along the O-X direction, the length of the first microstructure along the O-Y direction is greater than the length of the second microstructure along the O-Y direction, and the length of the first microstructure along the O-X direction is smaller than the length of the second microstructure along the O-X direction; or
the first microstructure is oval or gourd-shaped, the second microstructure is rhombic, spindle-shaped with included angles at two ends in a longitudinal direction, or circular, both ends of the first microstructure along the O-Y direction exceed the second microstructure, and both ends of the second microstructure along the O-X direction exceed the first microstructure.
